(19) United States
(12) Patent Application Publication
(10) Pub. No.: US 2015/0088621 A1
(43) Pub. Date: Mar. 26, 2015

(54) INPUT DEVICE, SIGNAGE SERVER, AND INPUT METHOD

(71) Applicant: PANASONIC CORPORATION, Osaka (JP)

(72) Inventors: Hiroki SHINOHARA, Kyoto (JP); Koichiro Yamaguchi, Osaka (JP)

(21) Appl. No.: 14/462,503

(22) Filed: Aug. 18, 2014

(30) Foreign Application Priority Data
Sep. 26, 2013 (JP) 2013-199521
Jul. 14, 2014 (JP) 2014-143815

(51) Int. Cl. G06F 3/0481; H04L 29/08; G06Q 30/02; G06F 17/30

(52) U.S. Cl. CPC G06F 3/0481; G06F 17/30345; H04L 67/10; G06Q 30/0241
USPC 705/14.4

(57) ABSTRACT

An input device of the present disclosure is an input device which performs change of a content in conjunction with a display of a content of a signage terminal, the input device including a change instructing unit configured to input a change instruction with respect to the content displayed on the signage terminal, and a transmitting unit configured to transmit a device ID, which specifies the signage terminal, and the change instruction.

### BACKGROUND OF THE INVENTION

1. Field of the Invention

The present disclosure relates to an input device, a signage server, and an input method for updating advertising information displayed on a signage display device.

2. Description of the Related Art

The use of digital signage is increasing not only in large-scale facilities, but also in small-scale facilities such as stores. In the digital signage of the store, a plurality of screens are often sequentially changed like a slide show so as to introduce recommended products continuously to present information to a customer.

PTL 1 discloses a method in which a portable terminal transmits a photographed image of a content displayed on a display device and a requesting message including position and time at a photographing time point to a content distribution server, and the content distribution server searches for a display device existing at the received position, searches for a content similar to the received image at the received time, and specifies the display device displaying the content.

### CITATION LIST

### Patent Literature

PTL 1: Unexamined Japanese Patent Publication No. 2011-76336

In the small-scale facilities, the updating of the advertising information of the digital signage is not carried out by a professional operator, but is often carried out by employees of the store.

The advertising information often needs to be updated during the open hours of the store, for example, at the time of product change due to time sale, sold-out stock, and the like.

Thus, it is desirable to easily update the advertising information during the open hours of the store without going through trouble of having the employee of the store specify which portion of which advertising information to update.

### SUMMARY OF THE INVENTION

The present disclosure provides an information updating device for easily changing display-content information while checking content information of a content displayed on a display device.

An input device according to the present disclosure is an input device that changes the content in conjunction with a display of the content of a signage terminal, and includes a change instructing unit configured to input a change instruction with respect to the content displayed on the signage terminal, and a transmitting unit configured to transmit a device ID, which specifies the signage terminal, and the change instruction.

The input device according to the present disclosure can easily change advertising information in conjunction with advertising information displayed on the signage terminal.

### BRIEF DESCRIPTION OF DRAWINGS

FIG. 1 is a block diagram of a signage system according to a first exemplary embodiment;

FIG. 2 is a view showing one example of a display of advertising information in a signage terminal according to the first exemplary embodiment;

FIG. 3 is a view describing a data structure of the advertising information of FIG. 2;

FIG. 4 is a view showing one example of a template DB according to the first exemplary embodiment;

FIG. 5 is a view showing one example of a business category DB according to the first exemplary embodiment;

FIG. 6 is a view showing one example of a content DB according to the first exemplary embodiment;

FIG. 7 is a view showing one example of a device management DB according to the first exemplary embodiment;

FIG. 8 is a flowchart of a displaying process of the advertising information in the signage terminal according to the first exemplary embodiment;

FIG. 9 is a view describing update of the content of the advertising information according to the first exemplary embodiment;

FIG. 10 is a view briefly describing a process of update of the content of the advertising information according to the first exemplary embodiment;

FIG. 11 is a flowchart showing a process of a content specifying unit according to the first exemplary embodiment;

FIG. 12 is a flowchart showing a process of an updating area specifying unit according to the first exemplary embodiment;

FIG. 13 is a view showing one example of a keyword table according to the first exemplary embodiment;

FIG. 14 is a flowchart showing a process of an updating unit according to the first exemplary embodiment;

FIG. 15 is a view describing update of the content of the advertising information according to a second exemplary embodiment;

FIG. 16 is a view briefly describing a process of update of the content of the advertising information according to the second exemplary embodiment;

FIG. 17 is a view describing the update of the content of the advertising information according to a third exemplary embodiment;

FIG. 18 is a view briefly describing a process of update of the content of the advertising information according to the third exemplary embodiment; and

FIG. 19 is a view describing the update of the content of the advertising information according to a fourth exemplary embodiment.

### DETAILED DESCRIPTION OF THE PREFERRED EMBODIMENTS

Hereinafter, exemplary embodiments will be described in detail with reference to the drawings as appropriate. Description in more detail than necessary will be omitted. For example, the detailed description of the already well-known matter and the redundant description on substantially the same configuration may be omitted. This is to prevent the following description from becoming unnecessarily redundant and to facilitate the understanding of those skilled in the art.

The applicant provides the accompanying drawings and the following description to enable those skilled in the art to fully understand the present disclosure, and do not intend to limit the subject matter described in the claims with the drawings and the description.

Hereinafter, the exemplary embodiments of the present disclosure will be described with reference to the drawings.

### First Exemplary Embodiment

A signage system according to the present exemplary embodiment will be described below.

### [1-1. Configuration of Signage System]

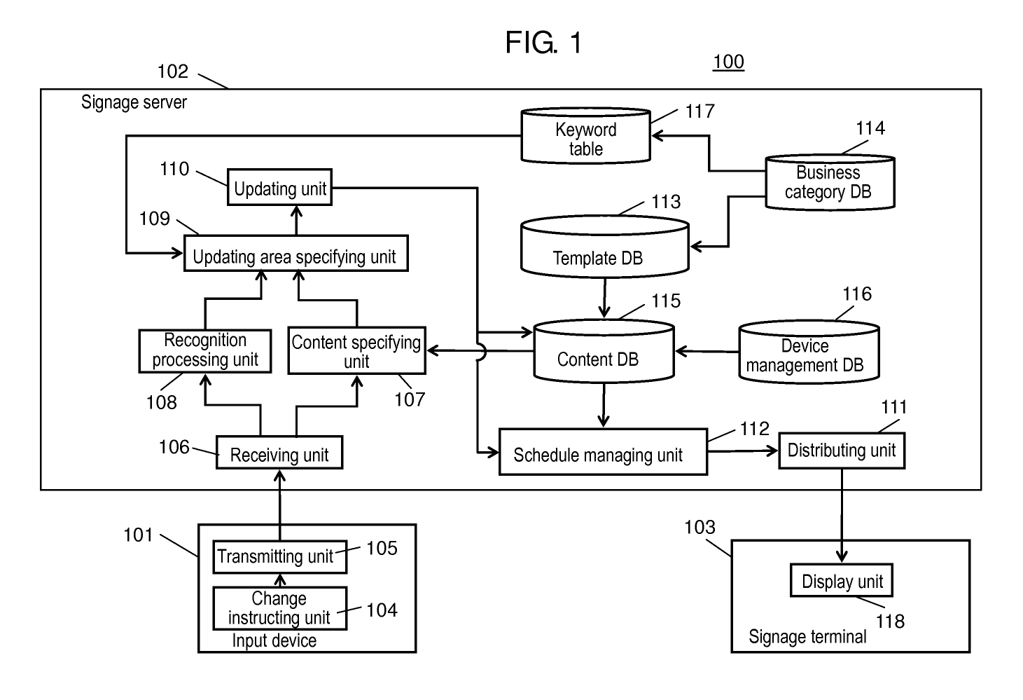

FIG. 1 is a block diagram of a signage system according to the present exemplary embodiment.

Signage system 100 is configured by input device 101, with which an employee of a store issues a change instruction of advertising information, signage server 102 that accepts change in the advertising information and reflects the change information on the content of the signage, and signage terminal 103 that receives and displays the content of the signage. Input device 101 is a portable device such as a smartphone.

Input device 101 includes change instructing unit 104 and transmitting unit 105. Change instructing unit 104 has a function of change instruction by speech from a microphone, change instruction by character input from a touch panel, and the like. Transmitting unit 105 transmits the change instruction to signage server 102.

Change instructing unit 104 is realized, for example, by a display device such as a liquid crystal display, and a processor that executes a predetermined process. Transmitting unit 105 is realized, for example, by a wireless or wired communication device and a processor that executes a predetermined process.

Signage server 102 is configured by receiving unit 106 that accepts the change instruction of the advertising information from input device 101, content specifying unit 107 that specifies which content the change instruction of the advertising information is, recognition processing unit 108 that converts to text and extracts a keyword from the text if the content information of the change instruction of the advertising information is speech, extracts a keyword from the text if the content information of the change instruction of the advertising information is text; updating area specifying unit 109 that specifies an updating area from the content specified by content specifying unit 107 and the keyword extracted by recognition processing unit 108; updating unit 110 that updates the specified updating area; distributing unit 111 that distributes the content to signage terminal 103; schedule managing unit 112 that manages a distribution schedule of the content, which is the advertising information, to signage terminal 103; template DB 113 that manages a template defining a display format of the content for each type of advertising information; business category DB 114 that manages a text item that can be used in the template for each type of advertising information; content DB 115 that manages a playlist defining a reproduction order of the content; device management DB 116 that manages device information for specifying signage terminal 103 displaying the advertising information; and keyword table 117 in which the text item that can be used in the template for each type of advertising information is associated with the keyword used in the advertising information by business category.

Receiving unit 106 and distributing unit 111 are realized, for example, by a wireless or wired communication device, and a processor that executes a predetermined process. Content specifying unit 107, recognition processing unit 108, updating area specifying unit 109, updating unit 110, and schedule managing unit 112 are realized by a processor that executes a predetermined process. Such functions may be realized with one processor, or may be assigned to and realized with a plurality of processors. Template DB 113, business category DB 114, content DB 115, device management DB 116, and keyword table 117 are, for example, realized by an optically-readable or a magnetically-readable recording medium.

Signage terminal 103 includes display unit 118 that receives a content from signage server 102, and displays the received content.

Display unit 118 is realized, for example, by a wireless or wired communication device, a display device such as a liquid crystal display, and a processor that executes a predetermined process.

### [1-2. Structure of Advertising Information]

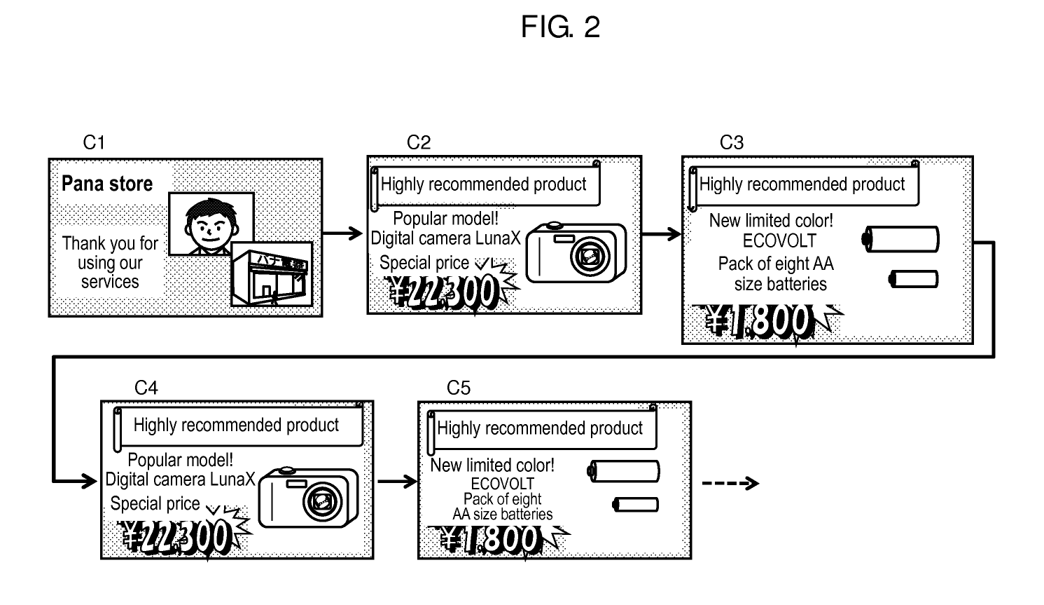

FIG. 2 is a view showing one example of a display of the advertising information in signage terminal 103. The advertising information is an advertisement for an electrical appliance store, and contents, which are the advertising information, are displayed in order. In content C1, the text “Pana Store” and “Thank you for using our services” which indicate that content C1 is an advertisement for the electrical appliance store are displayed, and a “salesperson” and an “appearance of store” are displayed with images. Content C1 is displayed for 20 seconds, for example. Content C2 is displayed after content C1. Content C2 is an advertisement for a digital camera, which is a product of the electrical appliance store. In content C2, the text “Highly Recommended Product”, “Popular Model!” “Digital Camera LunaX”, “Special Price ¥22,300” are displayed, and the “digital camera” is displayed with a picture. Content C2 is displayed for 10 seconds, for example. Content C3 is displayed after content C2. Content C3 is an advertisement for a dry cell battery, which is a product of the electrical appliance store. In content C3, the text “Highly Recommended Product”, “New Limited Color!”, “ECOVOLT”, “¥1,800 for Pack of Eight AA Size Batteries” are displayed, and a “dry cell battery” is displayed with an image. Content C3 is displayed for 10 seconds, for example. Content C4 is displayed after content C3. Content C4 has the same display-content information as content C2. Content C4 is displayed for 10 seconds, for example. Content C5 is displayed after content C4. Content C5 has the same display-content information as content C3. Content C5 is displayed for 10 seconds, for example.

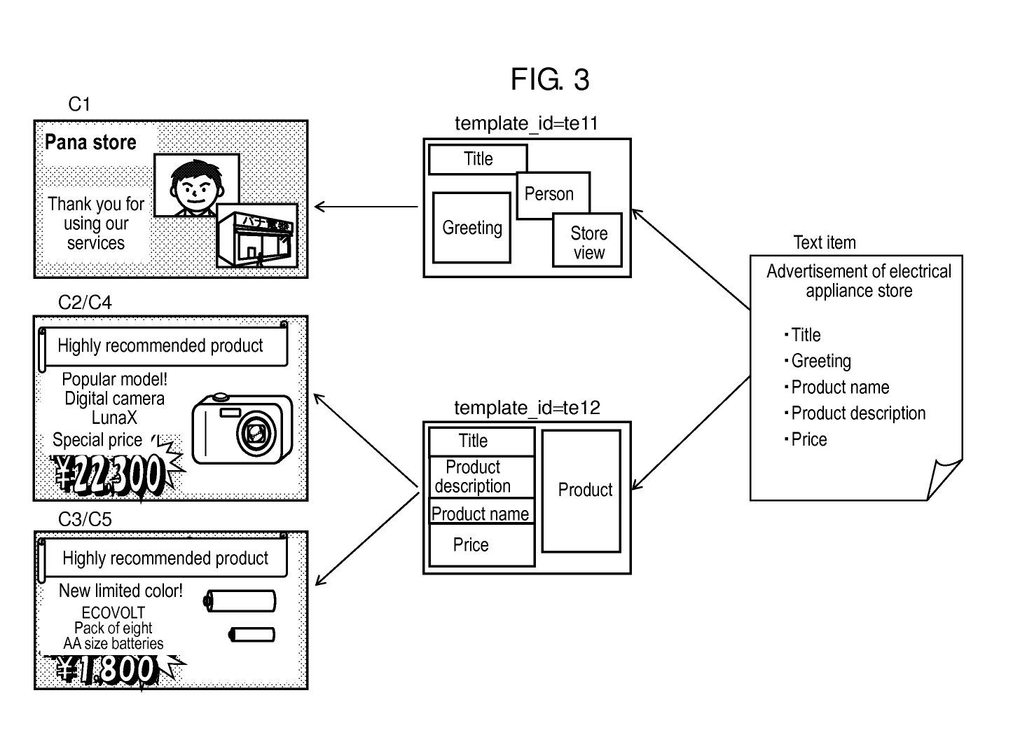

The data structure of the content, which is the advertising information, will be described below using one example of the content of FIG. 2. FIG. 3 is a view describing the data structure of the content, which is the advertising information, of FIG. 2. Contents C1, C2, C3, C4, and C5 are configured using a template managed by template DB 113. Content C1 uses the template in which the template_id is “te11”, and contents C2, C3, C4, and C5 use a template in which the template_id is “te12”. Each of the templates is configured by a rectangle indicating an arrangement region, and a text item and an image item in the rectangle. Template “te11” includes arrangement regions for the “title”, the “greeting”, the “person”, and the “store view”. Template “te12” includes arrangement regions for the “title”, the “product description”, the “product name”, the “price”, and the “product”. Among the types shown in the rectangles of the templates “te11”, “te12”, the text items are managed by business category DB 114. For the text item that can be used in the “advertisement of electrical appliance store”, the title, the greeting, the product name, the product description, and the price are managed as the text items. Therefore, in template “te11”, the rectangles where the “title” and the “greeting” are shown are for text, and the rectangles where the “person” and the “store view” are shown are for images other than the text. In template “te12”, the rectangles where the “title”, the “product description”, the “product name”, and the “price” are shown are for text, and the rectangle where the “product” is shown is for image other than the text.

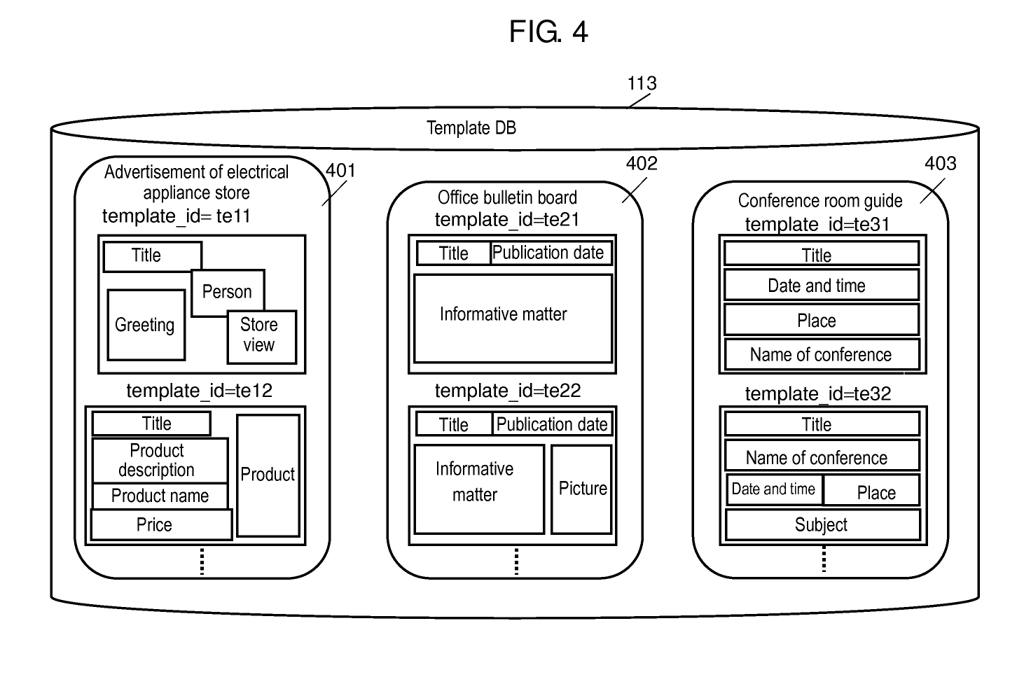

FIG. 4 is a view showing one example of template DB 113 according to the present exemplary embodiment. Template DB 113 manages the template defining the display format of the content for every type of advertising information. Template DB 113 manages template 401 for “advertisement of electrical appliance store”, template 402 for “office bulletin board”, and template 403 for “conference room guide”. The templates are configured by a rectangle indicating the arrangement region, and the text item and the image item in the rectangle. Template 401 for “advertisement of electrical appliance store” defines template_id “te11”, “te12” described in FIG. 3. Template 402 for “office bulletin board” defines template_id “te21”, “te22”. Template “te21” includes the arrangement regions for the “title”, the “publication date”, and the “informative matter”. Template “te22” includes the arrangement regions for the “title”, the “publication date”, the “informative matter”, and the “picture”. Template 403 for “conference room guide” defines template_id “te31”, “te32”. Template “te31” includes the arrangement regions for the “title”, the “date and time”, the “place”, and the “name of conference”. Template “te32” includes the arrangement regions for the “title”, the “name of conference”, the “date and time”, the “place”, and the “subject”.

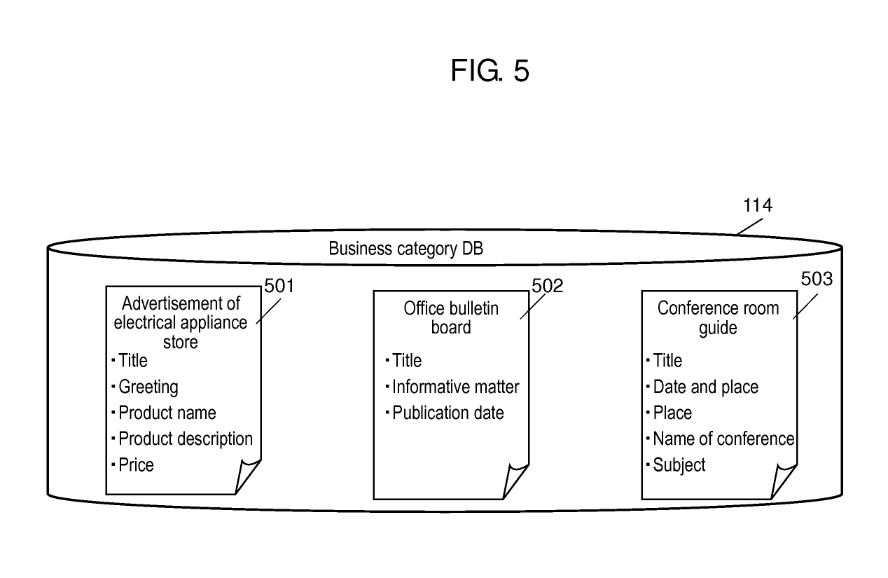

FIG. 5 is a view showing one example of business category DB 114 according to the present exemplary embodiment. Business category DB 114 manages the text item that can be used in the template for every type of advertising information managed in template DB 113. Business category DB 114 manages item 501 for text that can be used in the “advertisement of electrical appliance store”, item 502 for text that can be used in the “office bulletin board”, and item 503 for text that can be used in the “conference room guide”. For item 501 for text that can be used in the “advertisement of electrical appliance store”, the title, the greeting, the product name, the product description, and the price are managed. For item 502 for text that can be used in the “office bulletin board”, the title, the informative matter, and the publication date are managed. For item 503 for text that can be used in the “conference room guide”, the title, the date and time, the place, the name of conference, and the subject are managed.

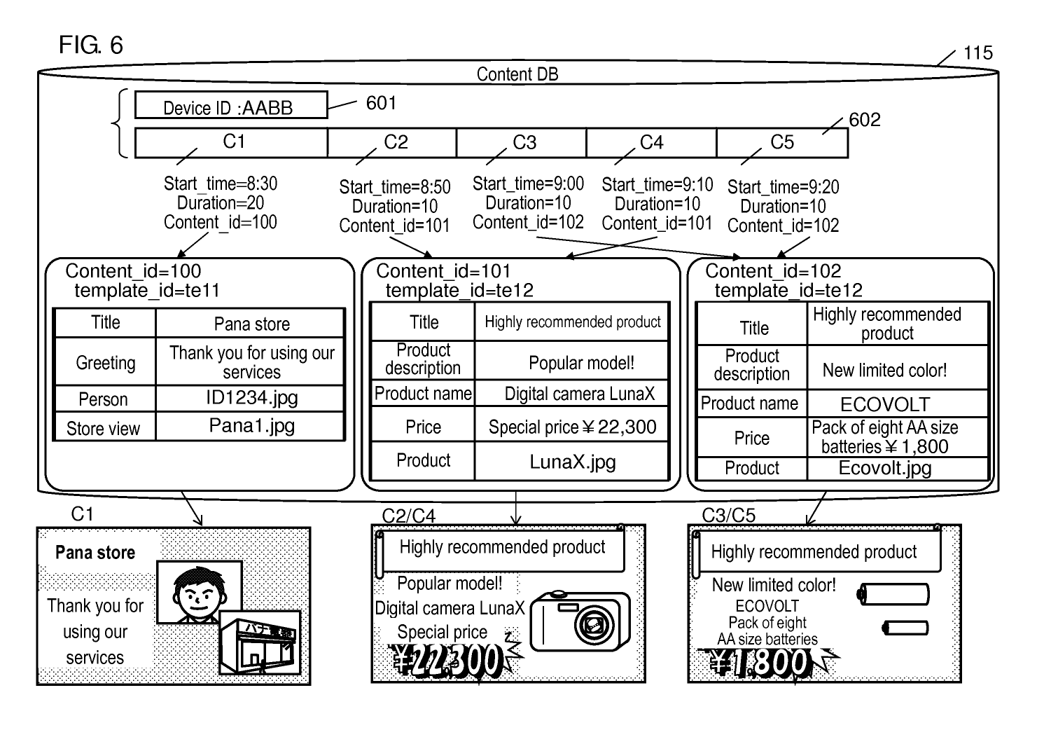

FIG. 6 is a view showing one example of content DB 115 according to the present exemplary embodiment. Content DB 115 of FIG. 6 will be described as one example with respect to the content of the advertising information of FIG. 2. Content DB 115 manages, as a set, device ID 601 which specifies signage terminal 103, and playlist 602 which defines the reproduction order of the content. Device ID 601 is an ID that specifies signage terminal 103 managed by device management DB 116, and device ID 601 is “AABB”. Playlist 602 is one example of the content of the advertising information of FIG. 2, and is defined in the order of the contents C1, C2, C3, C4, and C5 as the reproduction order. Each content is defined with Start_time which indicates the starting time of the display of the content, Duration which indicates the duration of the display of the content, and Content_id which specifies the content. The Content_id is hereinafter sometimes referred to as content ID.

In content C1, Start_time is defined as “8:30” past the hour, that is, 8 minutes 30 seconds past the hour, Duration is defined as “20” seconds, and Content_id is defined as “100”. In Content_id “100”, the template_id of template DB 113 uses “te11”, and the text “Pana Store” is associated with the item “title” shown in the rectangle of template “te11”, the text “Thank you for using our services” is associated with the item “greeting”, the image “ID1234.jpg” is associated with the item “person”, and the image “Pana1.jpg” is associated with the item “store view”. In content C2, Start_time is defined as “8:50”, that is, 8 minutes 50 seconds past the hour, Duration is defined as “10” seconds, and Content_id is defined as “101”. In Content_id “101”, the template_id of template DB 113 uses “te12”, and the text “Highly Recommended Product” is associated with the item “title” shown in the rectangle of template “te12”, the text “Popular Model!” is associated with the item “product description”, the text “Digital Camera LunaX” is associated with the item “product name”, the text “Special Price ¥22,300” is associated with the item “price”, and the image “LunaX.jpg” is associated with the item “product”. In content C3, Start_time is defined as “9:00”, that is, 9 minutes 00 seconds past the hour, Duration is defined as “10” seconds, and Content_id is defined as “102”. In content_id “102”, the template_id of template DB 113 uses “te12”, and the text “Highly Recommended Product” is associated with the item “title” shown in the rectangle of template “te12”, the text “New Limited Color!” is associated with the item “product description”, the text “ECOVOLT” is associated with the item “product name”, the text “¥1,800 for Pack of Eight AA Size Batteries” is associated with the item “price”, and the image “Ecovolt.jpg” is associated with the item “product”. In content C4, Start_time is defined as “9:10”, that is, 9 minutes 10 seconds past the hour, Duration is defined as “10” seconds, and Content_id is defined as “101”. Content_id “101” is defined as described above. In content C5, Start_time is defined as “9:20”, that is, 9 minutes 20 seconds past the hour, Duration is defined as “10” seconds, and Content_id is defined as “102”. Content_id “102” is defined as described above.

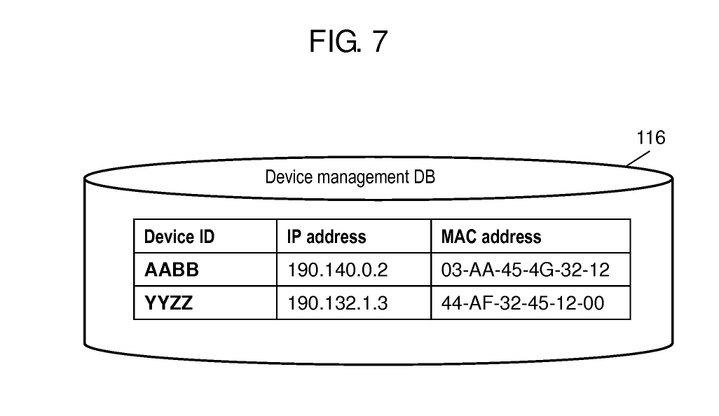

FIG. 7 is a view showing one example of device management DB 116 according to the present exemplary embodiment. Device management DB 116 manages an IP address for specifying a logical address of signage terminal 103, and an MAC address for specifying a physical address of signage terminal 103 in association with device ID to specify signage terminal 103. By way of example, definition is made such that the device ID “AABB” is associated with the IP address “190.140.0.2” and the MAC address “03-AA-45-4G-32-12”, and the device ID “YYZZ” is associated with the IP address “190.132.1.3” and the MAC address “44-AF-32-45-12-00”.

### [1-3. Display of Advertising Information]

Next, the operation of distributing the content, which is the advertising information, from signage server 102 to signage terminal 103, and displaying such content in signage terminal 103 will be described.

Signage terminal 103 displays the content distributed from distributing unit 111 of signage server 102 on display unit 118.

Schedule managing unit 112 transmits an instruction to distribute the content necessary for the display to distributing unit 111 periodically or as needed. For example, once a day, the content to be displayed on the distributing date may be collectively distributed to signage terminal 103 through distributing unit 111.

The specification of signage terminal 103 uses device ID 601 of content DB 115. When carrying out the distribution, distributing unit 111 specifies signage terminal 103 of a distributing destination using the IP address and the MAC address corresponding to the device ID of device management DB 116.

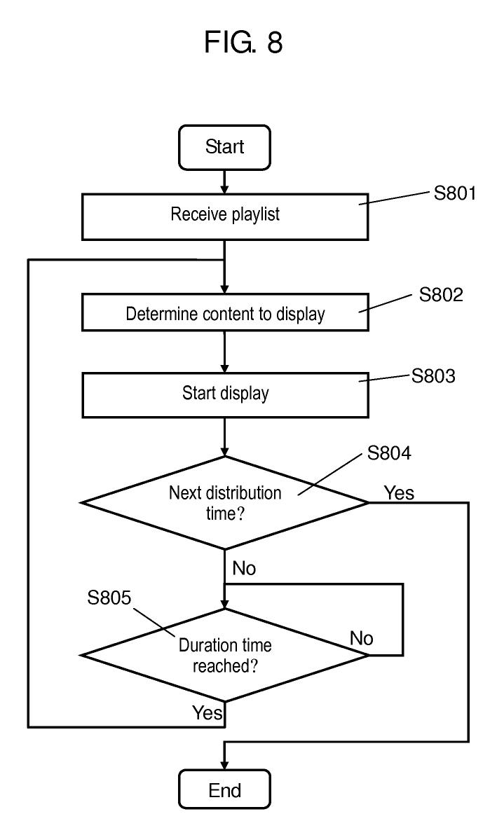

FIG. 8 is a flowchart of the displaying process of the advertising information in signage terminal 103 according to the present exemplary embodiment. The process of receiving the content distributed from distributing unit 111 in signage terminal 103 and displaying the content on display unit 118 will be described with reference to FIG. 8.

(S801) Display unit 118 receives playlist 602 of content DB 115 as the content, which is the advertising information, from distributing unit 111, and caches the content in a cache memory (not shown) of signage terminal 103.

(S802) Display unit 118 compares the current time and Start_time indicating the starting time of the display of the content of the playlist, and specifies the content ID of the content to be displayed. For example, if playlist 602 is the content of the advertising information of FIG. 2 and the current time is 10:00:00, the display target is content C1, that is, the content ID “100”.

(S803) Display unit 118 loads the content corresponding to the specified content ID “100” from the cache memory of signage terminal 103 by 10:08:30, which is the starting time of the display of the content, and starts the display at 10:08:30, which is the starting time of the display of the content.

(S804) Display unit 118 checks if the time of the next distribution of distributing unit 111 is reached, and if the next distribution time is reached (if Yes), the process is terminated, and if the next distribution time is not reached (if No), the process proceeds to S805.

(S805) Display unit 118 compares the current time with the time T in which the duration time Duration of the display of the content is added to the starting time of the display of the currently displayed content ID. If the time T has passed the current time (if Yes), the process returns to S802, and if the time T has not reached the current time (if No), the display is continued and the process again returns to S805. If the time T has passed the current time (if Yes), the process returns to S802 to display content C2, which is the next content.

The content of the advertising information is displayed on signage terminal 103 in the above manner.

### [1-4. Update of Advertising Information]

Next, the process of updating the content of the advertising information displayed on signage terminal 103 using input device 101 will be described.

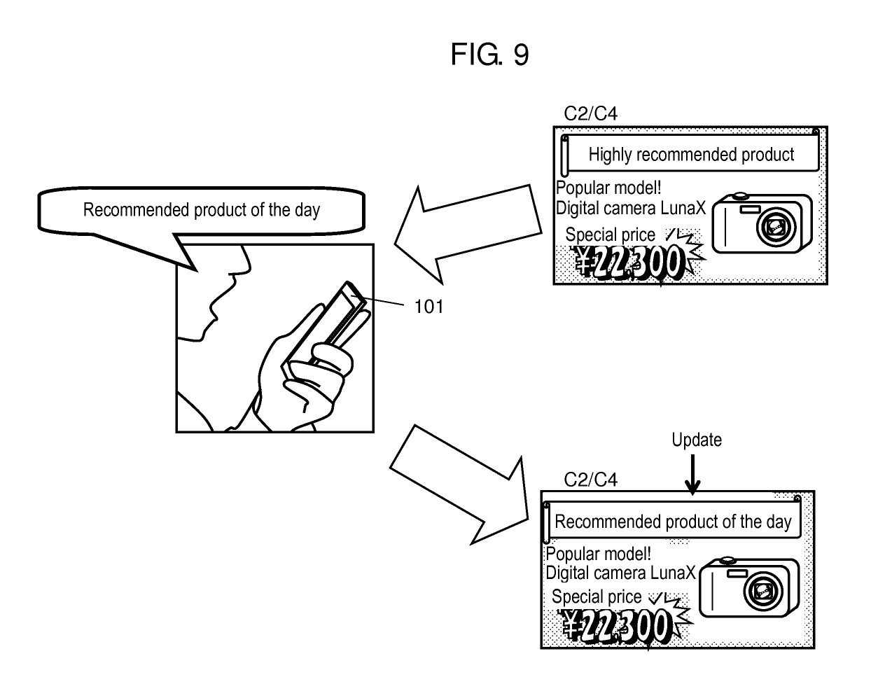

FIG. 9 is a view describing the update of the content of the advertising information according to the present exemplary embodiment. FIG. 9 describes a case of updating the display-content information of content C2 or content C4 when the content of the advertising information described in FIG. 2 is displayed on signage terminal 103. While content C2 or content C4 is displayed, the change instruction by speech is given from a microphone of change instructing unit 104 of input device 101. Specifically, the display of the “Highly Recommended Product” of content C2 or content C4 is changed to “Recommended Product of the Day”.

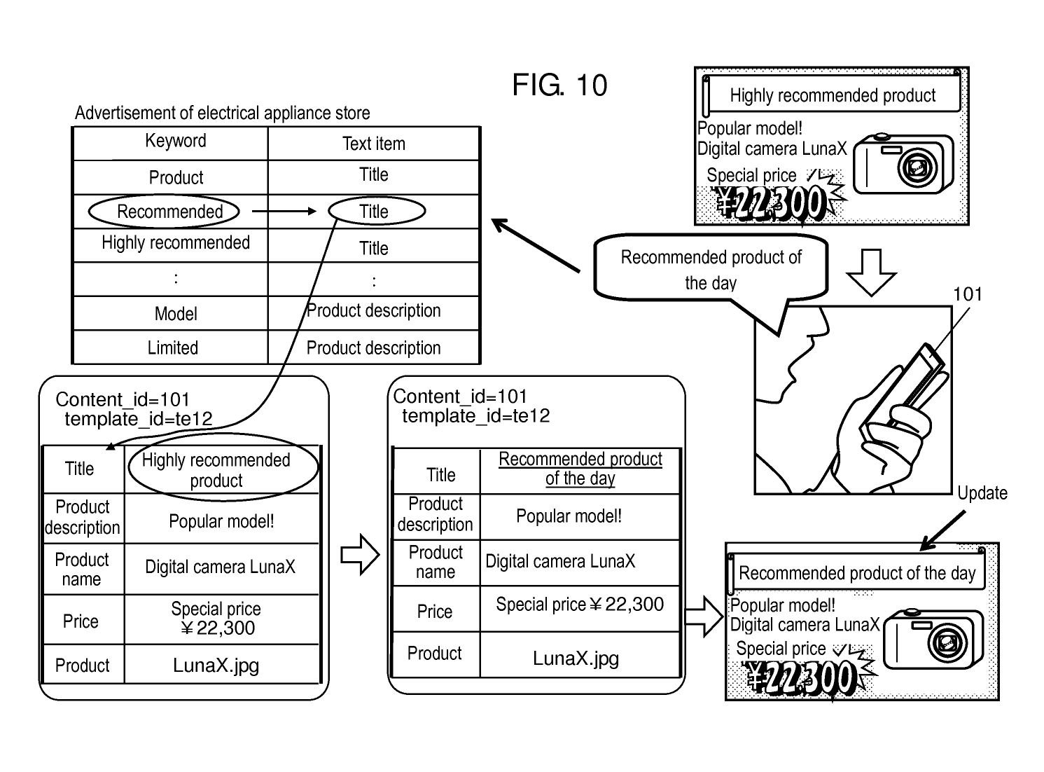

FIG. 10 is a view briefly describing the process of update of the content of the advertising information according to the present exemplary embodiment. While content C2 or content C4 is displayed, the change instruction “Recommended Product of the Day” is input by speech from the microphone of change instructing unit 104 of input device 101. Transmitting unit 105 transmits the input change instruction “Recommended Product of the Day” to signage server 102. Signage server 102 specifies the content ID corresponding to the change instruction, and specifies the template used by the specified content ID. Further, the change instruction by speech is converted to text. A keyword that matches the change instruction converted to text is searched using a keyword table, to be described later, in which the text item used by the template is associated with the keyword, and the text item with respect to the matching keyword is specified. With respect to the content ID to change, the specified text item is updated to the content information of the change instruction converted to text. Specifically, the content ID of corresponding content C2 or content C4 is “101”, and the template used is template “te12”. The keyword that matches the keyword table is “recommended”, and the corresponding text item is the “title”. The text “Highly Recommended Product” corresponding to the text item “title” of content ID “101” is updated to “Recommended Product of the Day”.

In order for input device 101 to transmit the change instruction to signage server 102 and update the content of the advertising information of signage terminal 103, input device 101 needs to notify, to signage server 102, which display of signage terminal 103 is to be updated. Thus, input device 101 needs to transmit the device ID for identifying signage terminal 103 to signage server 102 before or simultaneously with the change instruction. Input device 101 needs to acquire the device ID of signage terminal 103 beforehand.

The acquiring method of the device ID of signage terminal 103 in input device 101 includes acquiring, from signage terminal 103, the device ID of signage terminal 103 using Wi-Fi Direct (registered trademark) in which the devices directly communicate one-to-one, which is one of the functions of the wireless LAN, using infrared communication, and using other wireless functions. The acquiring method of the device ID may be arbitrary, and the present disclosure is not limited thereto.

While content C2 or content C4 is displayed, the change instruction “Recommended Product of the Day” by speech is input from the microphone of change instructing unit 104 of input device 101.

Transmitting unit 105 of input device 101 transmits, to signage server 102, input information of “Recommended Product of the Day”, which is the change instruction by speech, the device ID for specifying signage terminal 103, and the input time. The input time is a set of an input start time and an input end time.

The device ID may not be transmitted simultaneously with the change instruction, and may be transmitted before the change instruction.

Receiving unit 106 of signage server 102 receives the input information of “Recommended Product of the Day”, which is the change instruction by speech, the input time, and the device ID. Receiving unit 106 transmits the input time and the device ID to content specifying unit 107, and transmits the input information of “Recommended Product of the Day”, which is the change instruction by speech, to recognition processing unit 108.

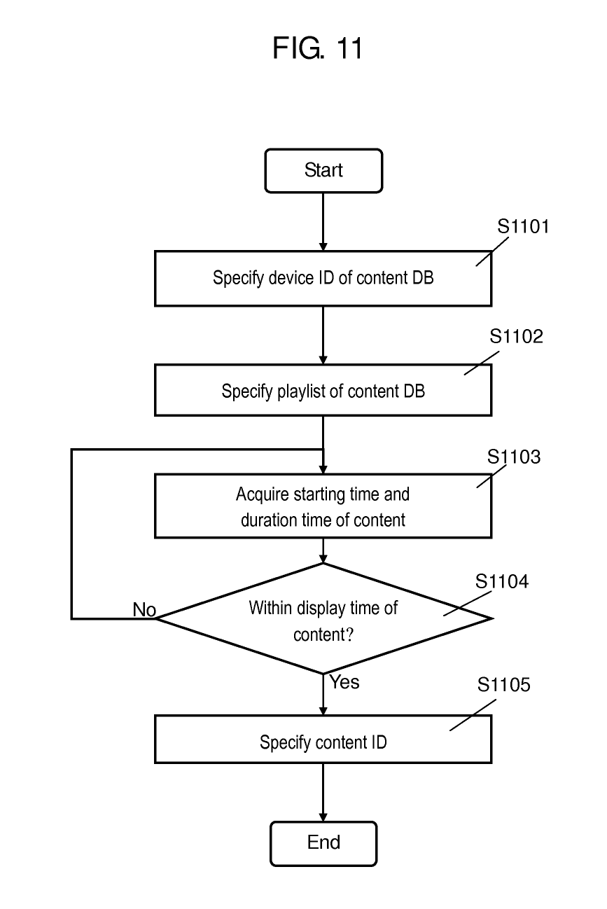

FIG. 11 is a flowchart showing the process of content specifying unit 107 according to the present exemplary embodiment.

(S1101) Content specifying unit 107 specifies matching device ID 601 of the contents managed in content DB 115 from the transmitted device ID and input time.

(S1102) Content specifying unit 107 specifies corresponding playlist 602 from specified device ID 601 and the input time.

(S1103) Content specifying unit 107 acquires the starting time and the duration time of the content of specified playlist 602.

(S1104) Content specifying unit 107 compares the starting time and the duration time of the content and the transmitted input time, and if the input time is within the display time of the content (if Yes), the process proceeds to S1105. If the input time is outside the display time of the content (if No), the process returns to S1103 and the process on the next content is performed.

(S1105) Content specifying unit 107 specifies the content ID to be updated. In FIG. 10, the specified content ID is “101”. Content specifying unit 107 transmits specified content ID “101” to updating area specifying unit 109.

In recognition processing unit 108, the input information “Recommended Product of the Day”, which is the transmitted change instruction by speech is recognized by speech recognition, and converted to the text information “Recommended Product of the Day”. Recognition processing unit 108 transmits the text information “Recommended Product of the Day” to updating area specifying unit 109.

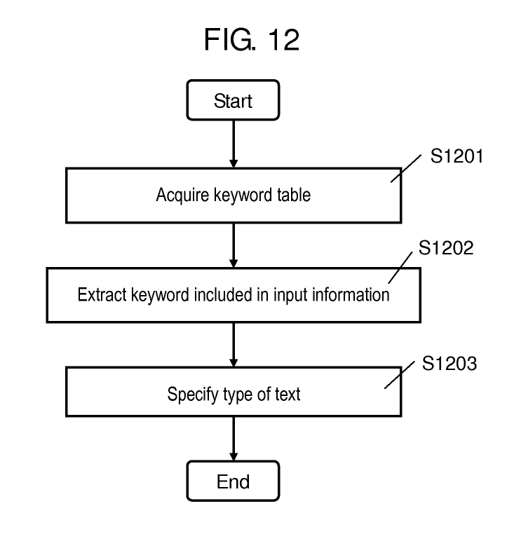

FIG. 12 is a flowchart showing the process of updating area specifying unit 109 according to the present exemplary embodiment.

(S1201) Updating area specifying unit 109 specifies template “te12” used by content ID “101” from content ID “101” specified by content specifying unit 107. It can be seen that specified template “te12” is template 401 for “advertisement of electrical appliance store” of template DB 113.

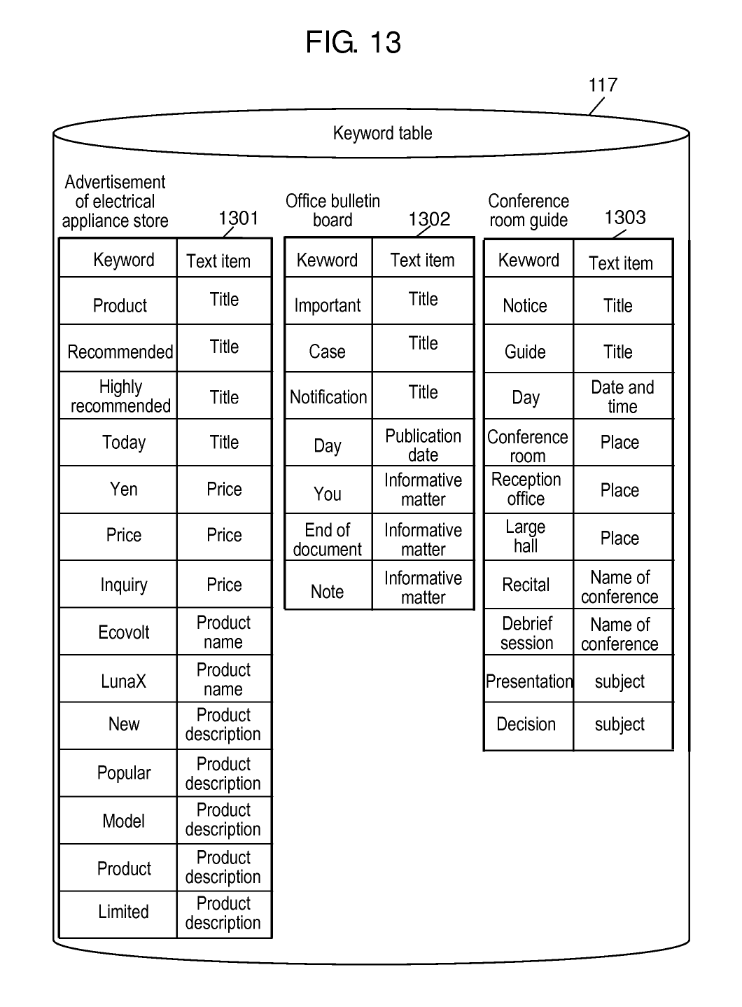

FIG. 13 is a view showing keyword table 117 according to the present exemplary embodiment. Keyword table 117 is a table in which the keyword used in the advertising information by business category is associated with the text item that can be used in the template for every type of advertising information of business category DB 114. The type of advertising information corresponds to the type of the advertising information defined in business category DB 114. Thus, keyword table 117 includes table 1301 for “advertisement of electrical appliance store”, table 1302 for “office bulletin board”, and table 1303 for “conference room guide”. In table 1301 for “advertisement of electrical appliance store”, keywords “product”, “recommended”, “highly recommended”, and “the day” correspond to the text item “title”, and the keywords “yen”, “price”, and “inquiry” correspond to the text item “price”, the keywords “ECOVOLT” and “LunaX” correspond to the text item “product name”, and the keywords “new”, “popular”, “model”, “product”, and “limited” correspond to the text item “product description”. In table 1302 for “office bulletin board”, the keywords “important”, “case”, and “notification” correspond to the text item “title”, the keyword “day” corresponds to the text item “publication date”, and the keywords “you”, “end of document”, and “note” correspond to the text item “informative matter”. In table 1303 for “conference room guide”, the keywords “notice” and “guide” correspond to the text item “title”, the keyword “date” corresponds to the text item “date and time”, the keywords “conference room”, “reception office”, and “large hall” correspond to the text item “place”, and the keywords “presentation” and “decision” correspond to the text item “subject”.

In updating area specifying unit 109, specified template “te12” is template 401 for “advertisement of electrical appliance store” of template DB 113, and thus the table corresponding to the template is template 401 of “advertisement of electrical appliance store”.

(S1202) Updating area specifying unit 109 searches in which keyword of template 401 of “advertisement of electrical appliance store” the text information for “advertisement of electrical appliance store”, i.e., “Recommended Product of the Day” is included. Template 401 of “advertisement of electrical appliance store” includes the keywords “recommended”, “the day”, and “product”.

(S1203) In template 401 of “advertisement of electrical appliance store”, the text item of the keywords “recommended” and “the day” is “title”, and the text item of the keyword “product” is “product description”. Among the extracted keywords, the text item is “title” in two keywords and is “product description” in one keyword. Updating area specifying unit 109 adopts the text item that matches the keyword of a greater number, and specifies the area to be changed as the text item “title”. Updating area specifying unit 109 transmits specified content ID “101”, text information “Recommended Product of the Day”, and the text item “title” to updating unit 110.

The specification of the text item in updating area specifying unit 109 is determined by the number of text items with respect to the keyword included in the text information, but the present disclosure is not limited thereto. For example, weighting may be given on the text item in view of the frequency of changing. Specifically, the weighting is determined such that “product description”>“price”>“title”>“product name”, and with respect to the text information “Recommended Product of the Day”, the text item of the keywords “recommended” and “the day” is “title”, and the text item of the keyword “product” is the “product description” in template 401 of “advertisement of electrical appliance store”. In the text items “title” and “product description”, higher weighting given to the “product description” and thus it is specified as the text item “product description”.

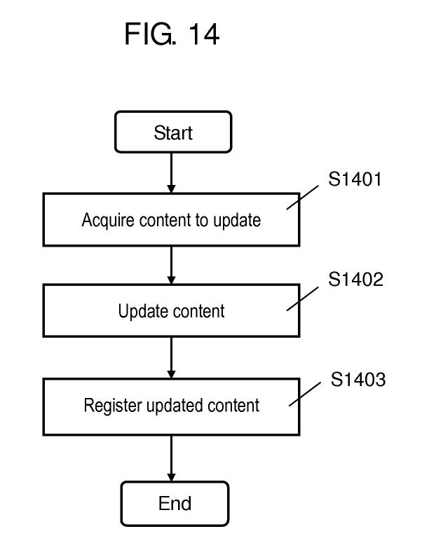

FIG. 14 is a flowchart showing the process of updating unit 110 according to the present exemplary embodiment.

(S1401) Updating unit 110 specifies content ID “101” to update from playlist 602 included in content DB 115 from content ID “101” acquired from updating area specifying unit 109.

(S1402) With respect to specified content ID “101”, updating area specifying unit 109 changes the “Highly Recommended Product” of the text item “title” of content ID “101” to “Recommended Product of the Day”, from the text information “Recommended Product of the Day” and the text item “title” acquired from updating area specifying unit 109.

(S1403) Updating unit 110 registers updated content ID “101” to content DB 115, updates content DB 115, and notifies schedule managing unit 112 that content ID “101” is updated.

When the notification that content ID “101” is updated is received from updating unit 110, schedule managing unit 112 transmits the instruction to distribute the updated content to distributing unit 111. Device ID 601 corresponding to the content to be updated of content DB 115 is used for the specification of signage terminal 103. In distributing the content, distributing unit 111 specifies signage terminal 103 of the distributing destination using the IP address and the MAC address corresponding to the device ID of device management DB 116.

The process of receiving the content distributed from distributing unit 111 in signage terminal 103 and displaying the content on display unit 118 is as described in FIG. 8. In the present exemplary embodiment, recognition processing unit 108 has been described as the configuration of signage server 102, but it may be the function of input device 101, and after speech information is converted to text information in input device 101, transmitting unit 105 may transmit the text information to receiving unit 106 of signage server 102.

### [1-5. Effect]

Accordingly, input device 101 of the present disclosure is input device 101 that performs change of the content in conjunction with the display of the content of signage terminal 103, and includes change instructing unit 104 configured to input the change instruction with respect to the content displayed on signage terminal 103, and transmitting unit 105 configured to transmit the device ID that specifies signage terminal 103 and the change instruction. Signage server 102 of the present disclosure is signage server 102 that controls the change instruction with respect to the content displayed on signage terminal 103 of input device 101 in conjunction with the display of the content of signage terminal 103, and includes receiving unit 106 configured to receive the device ID that specifies signage terminal 103 and the change instruction from input device 101, content specifying unit 107 configured to specify the content to be changed based on the device ID and the change instruction, updating area specifying unit 109 configured to specify the changing area with respect to the content specified by content specifying unit 107 based on the change instruction, updating unit 110 configured to change the content based on the changing area, and distributing unit 111 configured to transmit the changed content. Furthermore, signage server 102 of the present disclosure further includes keyword table 117 in which the item is associated with the keyword. The content is configured by a template defined by the arrangement region and the item arranged in the arrangement region, and updating area specifying unit 109 specifies the keyword that matches the changing instruction from the keywords of keyword table 117, and determines an item corresponding to the specified keyword for specifying the changing area with respect to the content specified by content specifying unit 107.

Thus, when the employee of the store desires to change the displayed content of signage terminal 103, the employee can update the advertising information without going through trouble of specifying which content information of which content to update, by simply activating input device 101 and inputting the content information to update in change instructing unit 104.

Furthermore, signage server 102 of the present disclosure further includes recognition processing unit 108 configured to convert the change instruction, which is speech, to text information.

The employee of the store can update the advertising information without going through trouble of specifying which content information of which content to update, by inputting the change instruction from change instructing unit 104 with a microphone.

### Second Exemplary Embodiment

A second exemplary embodiment with respect to the change of the advertising information in signage system 100 according to the present disclosure will be described below.

### [2-1. Update of Advertising Information]

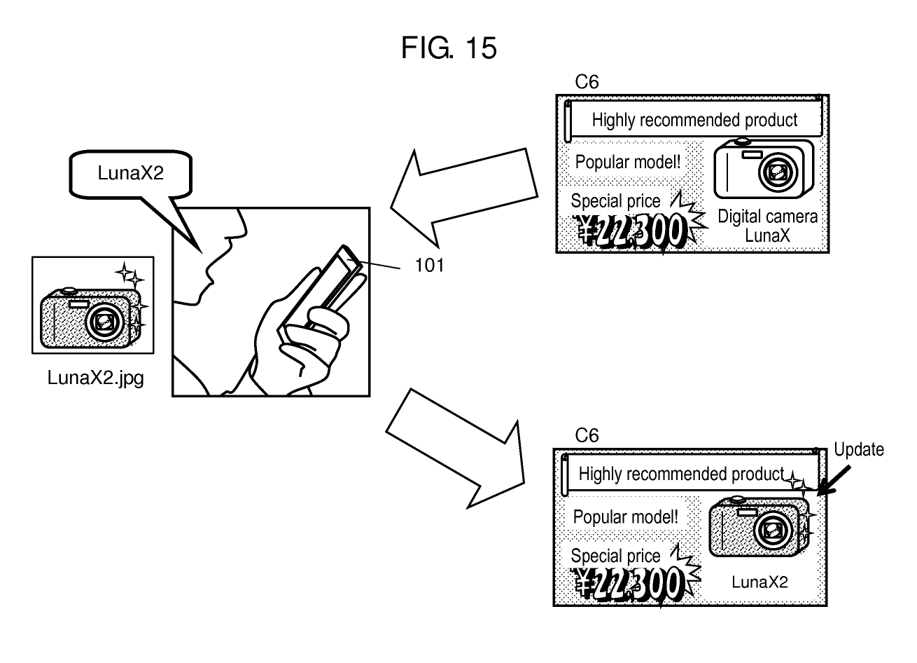

FIG. 15 is a view describing the update of the content of the advertising information according to the present exemplary embodiment. The present exemplary embodiment differs from the first exemplary embodiment in the data structure of the advertising information. The difference also lies in that change instructing unit 104 of input device 101 transmits the change instruction with the image data photographed by the camera function of input device 101 added to the change instruction.

FIG. 15 describes a case of updating the display-content information of content C6, for example, when the content of the advertising information is displayed on signage terminal 103. While content C6 is displayed, the change instruction by speech is given from the microphone of change instructing unit 104 of input device 101. The image data is transmitted with the change instruction. Specifically, the change instruction of changing the display of content C6 “Digital Camera LunaX” to “LunaX2”, and changing the image of the digital camera is given.

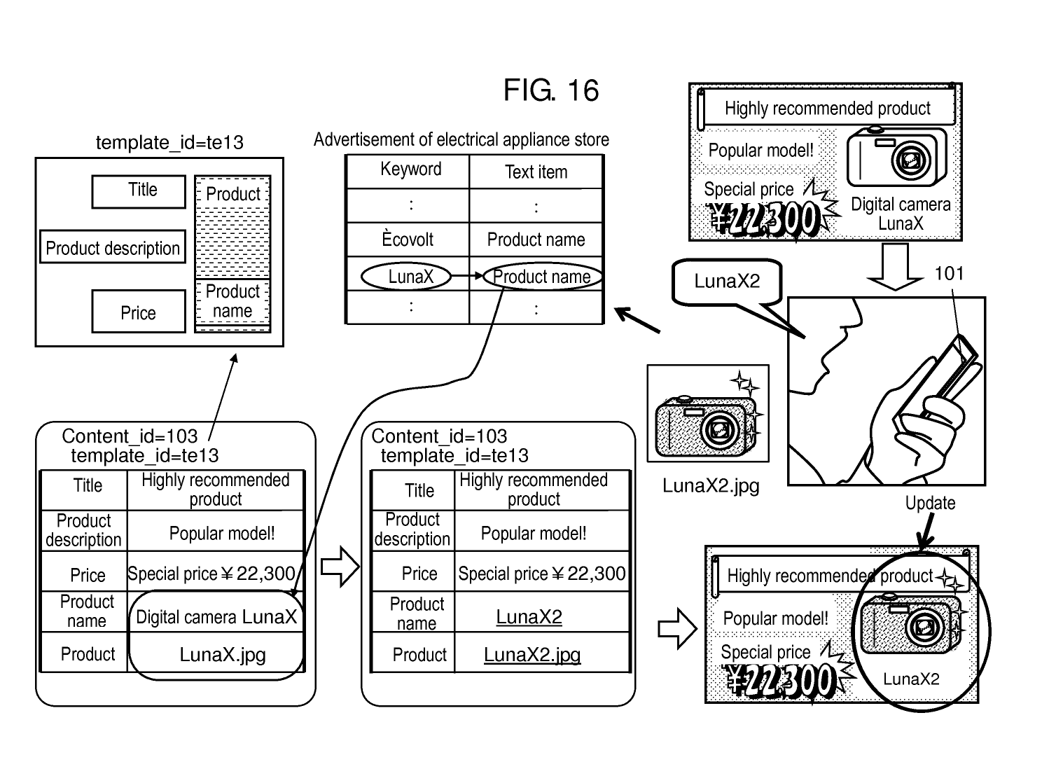

FIG. 16 is a view briefly describing the process of update of the content of the advertising information according to the present exemplary embodiment. While content C6 is displayed, the change instruction “LunaX2” is input by speech from the microphone of change instructing unit 104 of input device 101, and saved as the image data “LunaX2.jpg” of the digital camera photographed using the camera function. Transmitting unit 105 transmits the input change instruction “LunaX2” and the image data “LunaX2.jpg” to signage server 102.

The data structure of content C6 will now be described. As shown in the lower left of FIG. 16, content C6 uses a template in which the content ID is “103” and the template_id is “te13”. The template is configured by a rectangle showing the arrangement region, and the text item and the image item in the rectangle. Template “te13” includes the arrangement regions for the “title”, the “product description”, the “price”, the “product”, and the “product name”. Among the types shown in the rectangle of template “te13”, the text item is managed by business category DB 114. For the text item that can be used in the “advertisement of electrical appliance store”, the title, the greeting, the product name, the product description, and the price are managed as the text items. In template “te13”, the rectangles where the “title”, the “product description”, the “product name”, and the “price” are shown are for text, and the other “product” is for image other than the text. The second exemplary embodiment is different from the first exemplary embodiment in that the “product”, which is the image item, and the “product name” managed as the text item are associated and managed as a set.

Content ID “103” is defined with the text “Highly Recommended Product” associated with the item “title” shown in the rectangle of template “te13”, the text “Popular Model!” associated with the item “product description”, the text “Digital Camera LunaX” associated with the item “product name”, the text “Special Price ¥22,300” associated with the item “price”, and the image “LunaX.jpg” associated with respect to the item “product”.

Signage server 102 specifies the content ID corresponding to the change instruction, and specifies the template used by the specified content ID. The change instruction by speech is converted to text. The keyword that matches the change instruction converted to text is searched using the keyword table in which the text item used by the template is associated with the keyword, and the text item with respect to the matching keyword is specified. The specified text item is updated to the content information of the change instruction converted to text with respect to the content ID to change. If the image item is managed as a set with the text item, the image item is also updated to the content information of the change instruction. Specifically, the content ID of content C6 is “103”, and the template used is template “te13”. The keyword that matches the keyword table is “LunaX” and the corresponding text item is the “product name”. The text item “product name” is managed as a set with the image item “product”. The text “Digital Camera LunaX” corresponding to the text item “product name” of content ID “103” is updated to “LunaX2”, and the image data “LunaX.jpg” corresponding to the image item “product” is updated to “LunaX2.jpg”.

### [2-2. Effect]

Therefore, in signage server 102 of the present disclosure, the change instruction is speech and image data, and signage server 102 further includes recognition processing unit 108 configured to convert the speech of the change instruction to text information, and the template is configured by a set of a first arrangement region and an text item arranged in the first arrangement region, and a second arrangement region and an image item arranged in the second arrangement region, updating area specifying unit 109 specifies a keyword that matches the text converted in recognition processing unit 108 from the keywords of keyword table 117, determines a text item corresponding to the specified keyword, and specifies the changing area with respect to the content specified in content specifying unit 107.

Thus, the image can be updated without going through trouble of specifying which image to update in the content in which a plurality of images are displayed, by defining the template in which the image is associated with the text.

In the present exemplary embodiment, the change instruction has been described as being transmitted with the image data photographed by the camera function of input device 101 added thereto, but the image data stored in input device 101 may also be used.

### Third Exemplary Embodiment

A third exemplary embodiment with respect to the change of the advertising information in signage system 100 according to the present disclosure will be described below.

### [3-1. Update of Advertising Information]

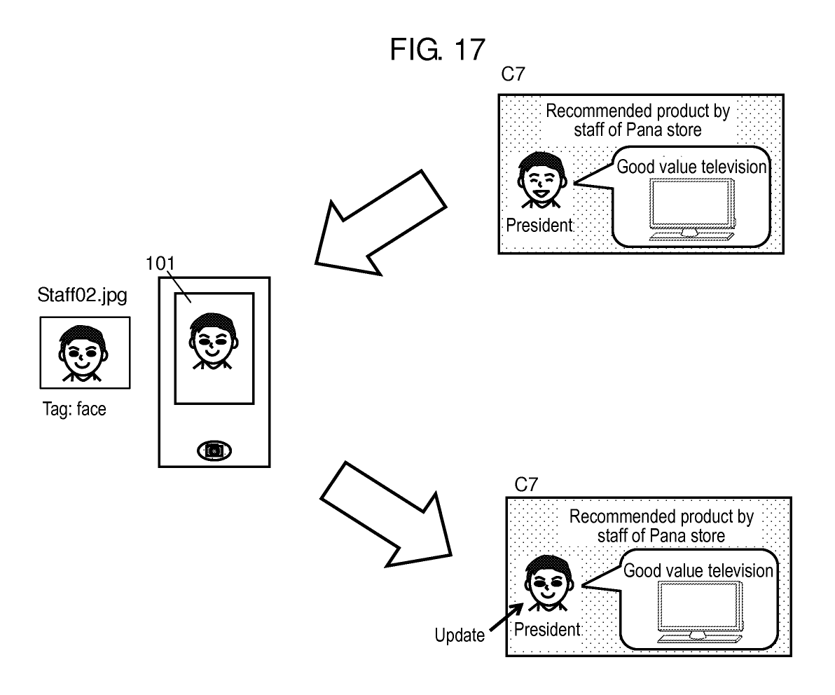

FIG. 17 is a view describing the update of the content of the advertising information according to the present exemplary embodiment. The present exemplary embodiment differs from the first exemplary embodiment in the data structure of the advertising information. Further, the difference also lies in that change instructing unit 104 of input device 101 further has a function of change instruction using the image data photographed by the camera function. Updating area specifying unit 109 of signage server 102 differs in the specifying procedure of content ID “101” to update.

FIG. 17 describes a case of updating the display-content information of content C7, for example, when the content of the advertising information is displayed on signage terminal 103. While content C7 is displayed, the change instruction using the image data photographed by the camera of change instructing unit 104 of input device 101 is given. Specifically, the change instruction to change the display of the image of “president” of content C6 to the image of a different “president” is given. The image data to change is “Staff02.jpg”, and such image data includes a tag “face”.

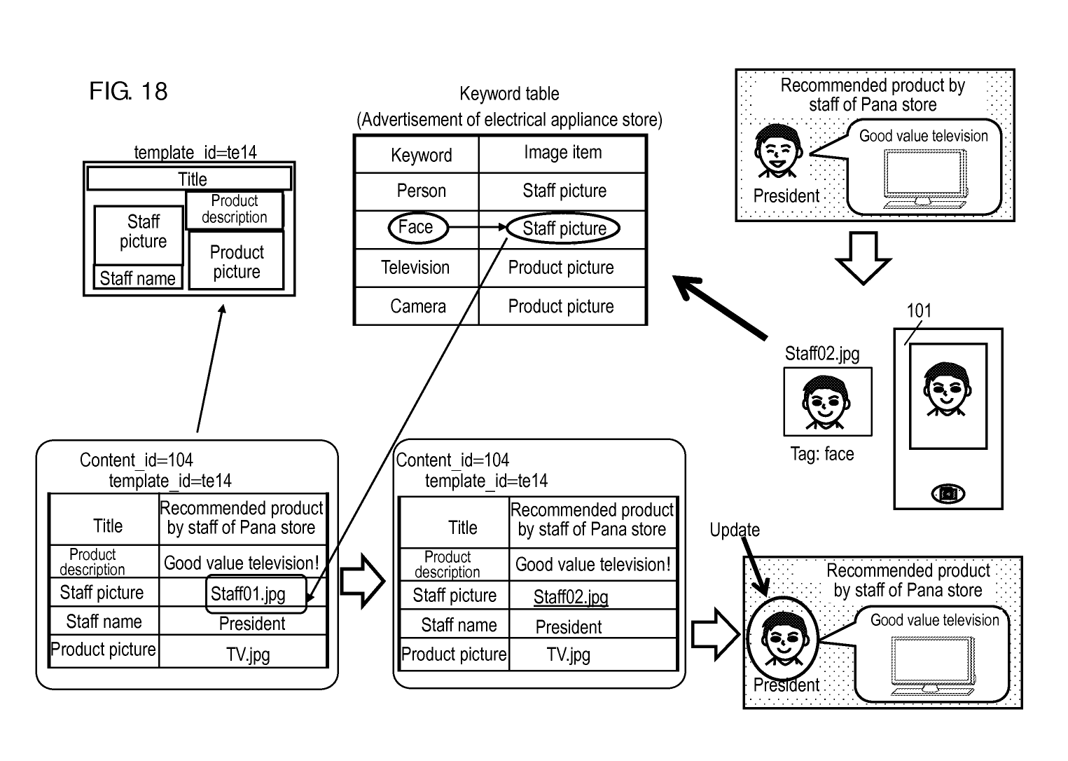

FIG. 18 is a view briefly describing the process of update of the content of the advertising information according to the present exemplary embodiment. While content C7 is displayed, the change instruction “Staff02.jpg” is given using the image data photographed using the camera function of change instructing unit 104 of input device 101. Transmitting unit 105 transmits input change instruction “Staff02.jpg” to signage server 102.

The data structure of content C7 will now be described. As shown in the lower left of FIG. 18, content C7 uses the template in which the content ID is “104” and the template_id is “te14”. The template is configured by a rectangle showing the arrangement region, and a text item and an image item in the rectangle. Template “te14” includes the arrangement regions for the “title”, the “staff picture”, the “staff name”, the “product description”, and the “product picture”. Among the types shown in the rectangle of template “te14”, the image item is managed by business category DB 114. For the image item used in the “advertisement of electrical appliance store”, the staff picture and the product description are managed as the image items. In template “te14”, the rectangles where the “staff picture” and the “product picture” are shown are for image, and the rectangles where the “title”, the “staff name” and the “product description” are shown are for text other than the image. The third exemplary embodiment is different from the first exemplary embodiment in that the item managed by business category DB 114 is the image item.

Content ID “104” is defined with the text “recommended product by staff of Pana Store” associated with the item “title” shown in the rectangle of template “te14”, the text “Good Value Television!” associated with the item “product description”, the image “Staff02.jpg” associated with the item “staff picture”, the text “President” associated with the item “staff name”, and the image “TV.jpg” associated with the item “product picture”.

The keyword table is a table in which the keyword used in the advertising information by business category is associated with the image item that can be used in the template for each type of advertising information. The keyword table used in FIG. 18 is the table for the “advertisement of electrical appliance store”. In the table for the “advertisement of electrical appliance store”, the keywords “person” and “face” correspond to the image item “staff picture”, and the keywords “television” and “camera” correspond to the image item “product picture”.

Signage server 102 specifies the content ID corresponding to the change instruction, and specifies the template used by the specified content ID. The keyword that matches a tag included in the image data, which is the change instruction, is searched using the keyword table in which the image item used by the template is associated with the keyword, and the image item with respect to the matched keyword is specified. The specified image item is updated to the image data of the change instruction with respect to the content ID to change. Specifically, the content ID of content C7 is “104”, and the template used is template “te14”. The keyword that matches the keyword table is the “face”, and the corresponding image item is the “staff picture”. The image data “Staff01.jpg” corresponding to the image item “staff picture” of content ID “104” is updated to “Staff02.jpg”.

### [3-2. Effect]

As described above, in signage server 102 of the present disclosure, the change instruction is the image data, the image data includes a tag, updating area specifying unit 109 specifies the keyword that matches the tag from the keywords of keyword table 117 and determines an item corresponding to the specified keyword for specifying the changing area with respect to the content specified by content specifying unit 107.

Thus, the employee of the store can update the advertising information without going through trouble of specifying which content information of which content to update, by simply activating input device 101 and photographing the image data to update with change instructing unit 104 such as the camera.

The image data for change instruction is the image data photographed by the camera, but may be the image data accumulated in a storage region of input device 101.

### Fourth Exemplary Embodiment

A fourth exemplary embodiment with respect to the change of the advertising information in signage system 100 according to the present disclosure will be described below.

### [4-1. Update of Advertising Information]

In the first exemplary embodiment, the specification of the text item in updating area specifying unit 109 has been determined with the number of text items with respect to the keyword included in the text information, but in the present exemplary embodiment, the specification is not merely determined with the number of text items and the employee of the store may select whether to determine by performing weighting on the text item in view of the frequency of change.

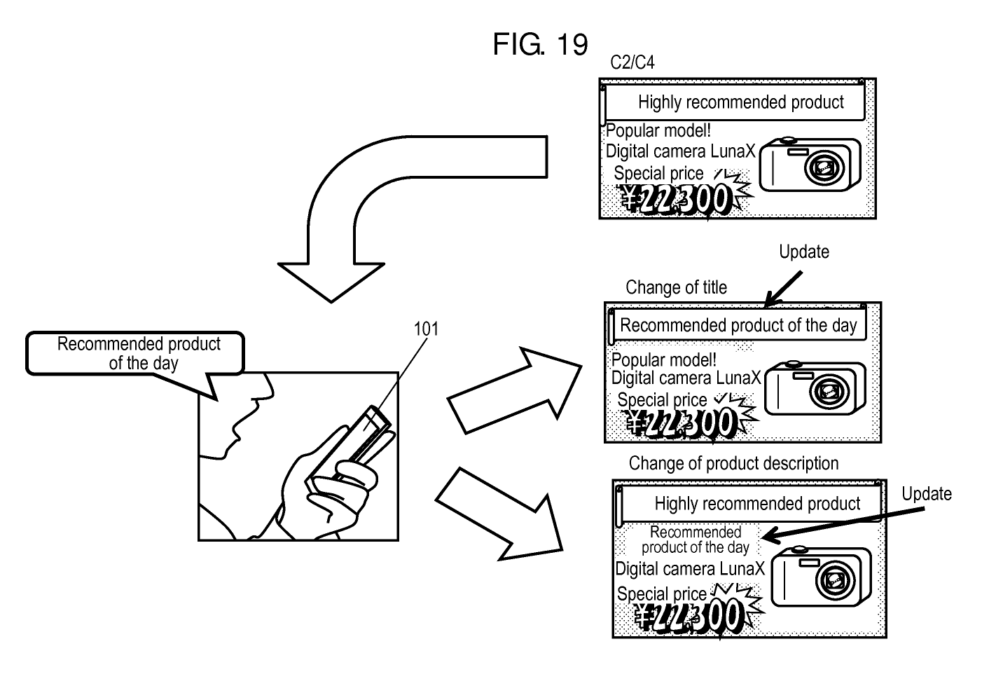

FIG. 19 is a view describing the update of the content of the advertising information according to the present exemplary embodiment.

FIG. 19 describes a case of updating the display-content information of content C2 or content C4, for example, when the content of the advertising information is displayed on signage terminal 103. While content C2 or content C4 is displayed, the change instruction by speech is given from the microphone of change instructing unit 104 of input device 101. Signage server 102 enables the employee of the store to select whether to change the display of “Highly Recommended Product” of content C2 or content C4 to “Recommended Product of the Day”, or to change the display of “Popular Model!” of content C2 or content C4 to “Recommended Product of the Day”.

### [4-2. Effect]

As described above, in signage server 102 of the present disclosure, updating area specifying unit 109 extracts candidates of a plurality of changing areas with respect to the content specified by content specifying unit 107, and carries out a check for specifying one of the candidates of the plurality of changing areas on input device 101.

Thus, since the updating area is not specified to one and the candidates are displayed to the employee of the store to enable the employee to select one of the candidates, erroneous determination can be reduced.

What is claimed is:

1. An input device which performs change of a content in conjunction with a display of a content of a signage terminal, the input device comprising:
a change instructing unit configured to input a change instruction with respect to the content displayed on the signage terminal; and
a transmitting unit configured to transmit a device ID, which specifies the signage terminal, and the change instruction.

2. A signage server which controls a change instruction with respect to content displayed on a signage terminal of an input device in conjunction with a display of the content of the signage terminal, the signage server comprising:
a receiving unit configured to receive a device ID, which specifies the signage terminal, and a change instruction from the input device;
a content specifying unit configured to specifiy a content to be changed based on the device ID and the change instruction;
an updating area specifying unit configured to specify a changing area with respect to the content specified by the content specifying unit based on the change instruction;
an updating unit configured to change the content based on the changing area; and
a distributing unit configured to distribute the changed content.

3. The signage server according to claim 2, further comprising:
a keyword table in which an item and a keyword are associated,
wherein the content is configured by a template defined with an arrangement region, and an item arranged in the arrangement region; and
the updating area specifying unit specifies a keyword that matches the change instruction from the keywords of the keyword table and determines an item corresponding to the specified keyword for specifying a changing area with respect to the content specified by the content specifying unit.

4. The signage server according to claim 2, wherein
the change instruction is speech, and
the signage server further comprises a recognition processing unit configured to convert the change instruction to text information.

5. The signage server according to claim 3, wherein
the change instruction is speech and image data,
the signage server further comprises a recognition processing unit configured to convert the speech of the change instruction to text information,
the template is configured by a set of a first arrangement region and a text item provided in the first arrangement region, and a second arrangement region and an image item provided in the second arrangement region, and
the updating area specifying unit specifies a keyword that matches a text converted in the recognition processing unit from the keywords of the keyword table, determines a text item corresponding to the specified keyword, and specifies a changing area with respect to the content specified by the content specifying unit.

6. The signage server according to claim 3, wherein
the change instruction is image data including a tag, and
the updating area specifying unit specifies a keyword that matches the tag from the keywords of the keyword table and determines an item corresponding to the specified keyword for specifying a changing area with respect to the content specified by the content specifying unit.

7. The signage server according to claim 2, wherein
the updating area specifying unit extracts candidates of a plurality of changing areas with respect to the content specified by the content specifying unit, and performs a check for specifying one candidate from the candidates of the plurality of changing areas on the input device.

8. An input method of performing change of a content in conjunction with a display of a content of a signage terminal, the input method comprising:
a change instructing step of inputting a change instruction with respect to the content displayed on the signage terminal; and
a transmitting step of transmitting a device ID, which specifies the signage terminal, and the change instruction.
